(19) United States
(12) Patent Application Publication
(10) Pub. No.: US 2022/0032356 A1
(43) Pub. Date: Feb. 3, 2022

(54) HYDRAULIC DRIVE SYSTEM FOR A PUNCHING APPARATUS

(71) Applicant: SALVAGNINI ITALIA S.P.A., Sarego (VI) (IT)

(72) Inventors: Claude Lucien BATTHEU, Sarego (VI) (IT); Ruggero BATTAGLIA, Sarego (VI) (IT)

(21) Appl. No.: 17/275,300

(22) PCT Filed: Sep. 30, 2019
(86) PCT No.: PCT/IB2019/058280

§ 371 Date: Mar. 11, 2021

(30) Foreign Application Priority Data
Oct. 1, 2018 (IT) 102018000009060

(51) Int. Cl. B21D 28/00; B21D 28/24; B30B 15/16; F15B 1/02; F15B 11/16

(52) U.S. Cl. CPC B21D 28/002; B21D 28/246; B30B 15/163; F15B 1/02; F15B 11/16; F15B 2211/71; F15B 2211/20561; F15B 2211/20576; F15B 2211/212; F15B 2211/27; F15B 2211/625; F15B 2211/20515

(57) ABSTRACT

A hydraulic drive system associable with a multi-press punching apparatus for operating a plurality of punching tools includes a plurality of hydraulic cylinders provided with respective pistons defining thrust chambers and return chambers inside the hydraulic cylinders and associated with corresponding punching tools, a reversible first pump connected to the thrust chambers and arranged to send oil to, or suck oil from, at least one of the thrust chambers so as to move the respective piston, a plurality of selector valves interposed between the first pump and the thrust chambers of the hydraulic cylinders and activable to connect the first pump to the thrust chambers, and a hydraulic accumulator connected to the return chambers and arranged for maintaining in said return chambers oil at a defined preload pressure.

The invention relates to machine tools for machining metal pieces and/or sheet metals and in particular it relates to a hydraulic drive system which can be installed on a multi-press punching apparatus of a punching machine for operating a plurality of punching tools in a separate and independent manner.

Punching machines are known which are equipped with multi-press or multi-tool punching apparatuses, i.e. comprising a plurality of punching tools or punches arranged adjacent and side by side on one or more rows, for example to form a matrix structure with parallel rows, and driven linearly in a separate and independent way to interact with the workpiece from respective presses, consisting of linear actuators, typically hydraulic cylinders. In this type of machine, the punching apparatuses comprise all the tools necessary to execute in sequence the machinings required on the piece. In this way, it is not necessary to perform tool change operations during the production cycle, thus allowing to eliminate both stops for tool replacement (thus increasing the productivity of the machine) and automatic devices for setting up and replacing the tools (simplifying the structure of the machine).

To perform the machinings correctly on the piece it is necessary to check the position, the displacement or stroke, and the speed along a respective working axis, generally vertical, of each punching tool, since these parameters depend on and are a function of the thickness and type of material of the workpiece and/or type of machining to be performed.

To drive and precisely control the movement of the tools, the known punching apparatuses are provided with hydraulic drive systems capable of supplying and therefore driving in a separate and independent manner the hydraulic cylinders whose pistons are connected to, and move, the respective tools, so as to produce a single machining or a plurality of machinings on the piece in the same working phase.

Known hydraulic drive systems generally comprise one or more hydraulic pumps driven by an electric motor, which supply with a high-pressure (up to 300 bar) hydraulic fluid (oil) a supply circuit connected to each hydraulic cylinder by means of suitable by-pass and pressure regulation valves. By means of the aforementioned valves, it is therefore possible to select the hydraulic cylinder, that is the tool to be driven, the direction of movement of the piston of the cylinder (i.e. a working stroke or a return stroke of the piston/tool) and the supply pressure of the hydraulic cylinder, i.e. the punching force that the tool exerts on the workpiece. The high pressure (up to 300 bar) with which the hydraulic pump feeds the supply circuit is calculated to ensure that one or more hydraulic cylinders of the punching apparatus exert maximum punching force on the workpieces.

However, in the usual machining processes only a small part (about 20%) of the machinings performed on the pieces requires the application of the maximum punching force, that is the maximum supply pressure for the hydraulic cylinders, the normally required supply pressure being much smaller (60-100 bar).

A disadvantage of the aforementioned hydraulic drive systems therefore lies in their high power consumption (necessary for pumping the oil in the high-pressure supply circuit) and in their overall low power efficiency (the oil pressure must in fact be reduced in most machinings).

Another disadvantage of such hydraulic drive systems lies in the fact that due to the high supply pressure and thermal dissipations due to the pressure reduction in the control valves of the hydraulic cylinders, the oil heats up and must therefore be cooled by appropriate cooling means, which make the punching apparatus more complex and expensive.

An object of the present invention is to improve the known hydraulic drive systems for multi-press punching apparatuses.

Another object is to provide and implement a hydraulic drive system for a multi-press punching apparatus having reduced power consumption and high energy efficiency.

A further object is to implement a hydraulic drive system which allows the punching apparatus to perform in an optimal manner the punching processes, in particular capable of driving and controlling the position, displacement and speed of each punching tool along a respective working axis in a precise and accurate way.

A further object is to provide a hydraulic drive system for a multi-press punching apparatus which is simple and low-cost with reduced and compact dimensions and space requirements.

These objects and others are achieved by a hydraulic drive system according to one of the claims set forth below.

The invention can be better understood and implemented with reference to the attached drawings which illustrate some exemplifying and non-limiting embodiments thereof, wherein:

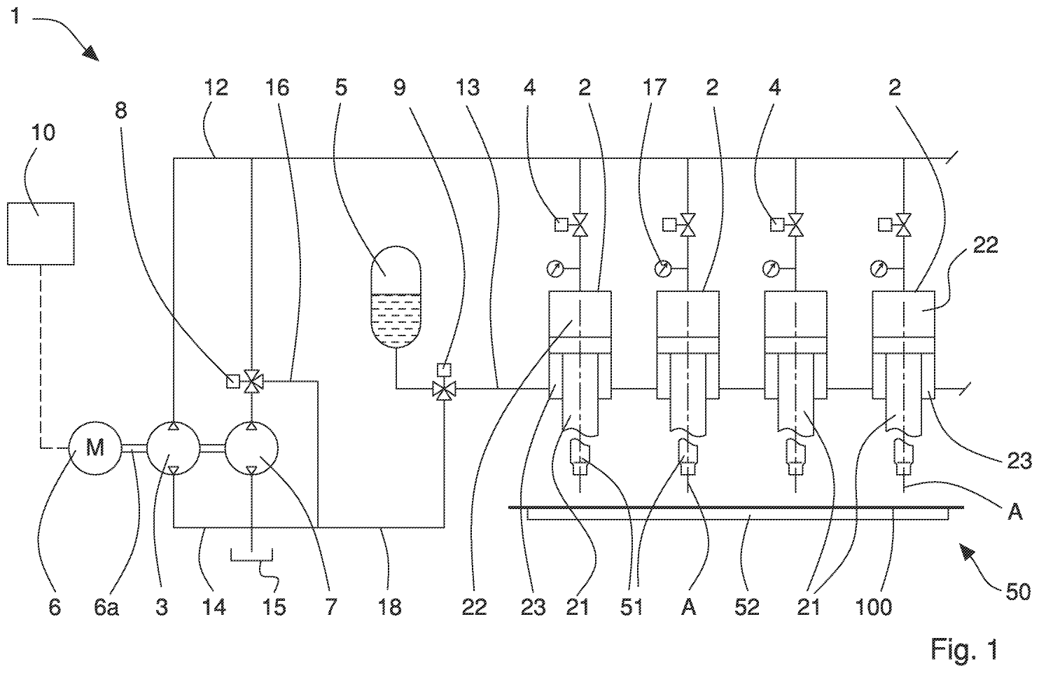

FIG. 1 is a diagram of the hydraulic drive system of the invention associated with a punching apparatus in a non-working configuration;

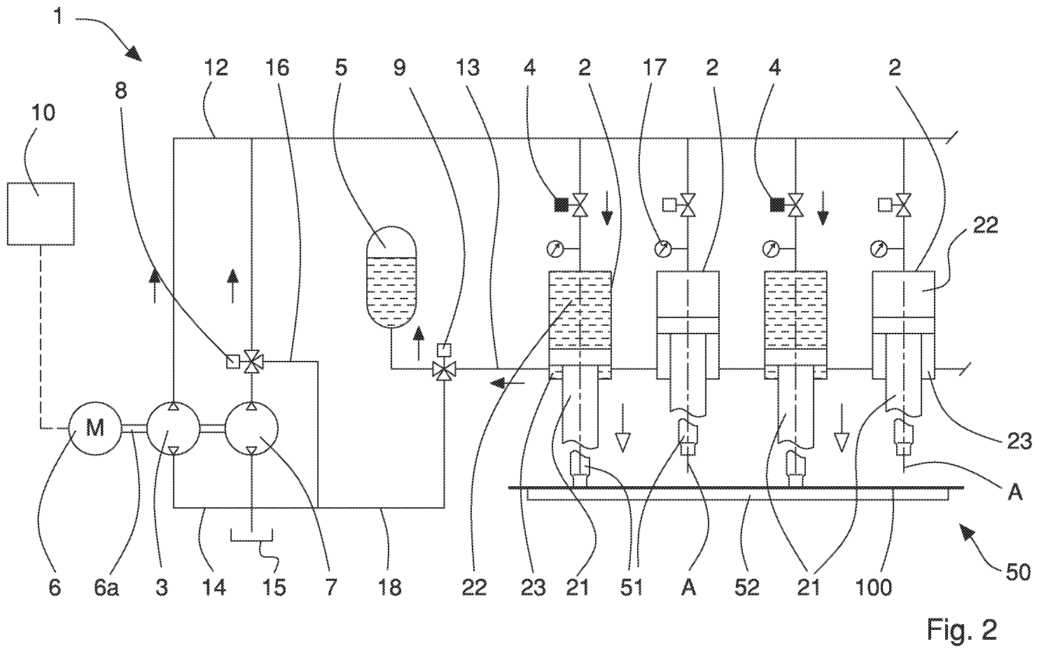

FIG. 2 is the diagram of FIG. 1 which illustrates the hydraulic drive system and the punching apparatus in a working configuration in which two hydraulic cylinders are driven to move respective punching tools against a workpiece;

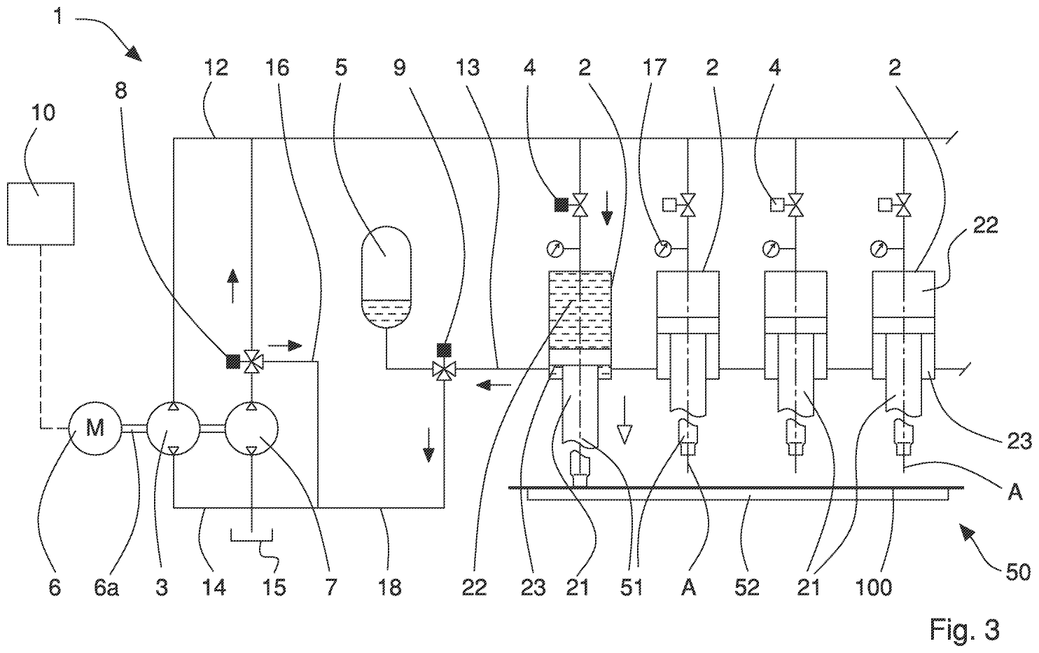

FIG. 3 is the diagram of FIG. 1 which illustrates the hydraulic drive system and the punching apparatus in a further working configuration in which a single punching tool is driven to operate on the piece.

With reference to FIG. 1, it shows the hydraulic drive system 1 of the invention associable with a multi-press punching apparatus 50 for operating a plurality of punching tools 51 of the aforementioned punching apparatus 50 along respective working axes A in a separate and independent manner so that the punching tools 51 interact with a workpiece 100, the latter positioned on a punching matrix 52 of the punching apparatus 50. The punching tools 51, in the number of four in the illustrated embodiment, can also be in a higher number and arranged on one or more rows side by side so as to form a matrix structure of punching tools 51.

The hydraulic drive system 1 comprises a plurality of hydraulic cylinders or jacks 2, each of which is associated and arranged to operate a respective punching tool 51. In detail, each hydraulic cylinder 2 comprises a respective piston 21 defining a thrust chamber 22 and a return chamber 23 inside the cylinder and is associated with a respective punching tool 51 to move the latter along the working axis A. More precisely, the piston 21 comprises a main body slidable inside the respective hydraulic cylinder 2 to form the two chambers 22, 21 of variable volume and a stem which comes out of the hydraulic cylinder 2 and is connected to the relevant punching tool 51 by means of connecting means of the punching apparatus 50, known and not shown in the figures.

The hydraulic drive system 1 further comprises a first pump 3 connected to the thrust chambers 22 of the hydraulic cylinders 2 in particular by means of a supply circuit 12 formed by a plurality of supply ducts. The first pump 3 is of the reversible type and arranged to send pressurized oil into one or more of the thrust chambers 22, so as to push the respective pistons 21 along a working direction and allow the punching tools 51 associated therewith to interact with the piece 100, in a driving phase, or to suck oil from said thrust chambers 22 to allow the respective pistons 21 moving along a return direction, opposite to the working direction, for disengagement and removal of the punching tools 51 from the piece 100, in a sucking phase. In particular, in the driving phase the first pump 3 sends oil to a supply pressure P_{A} which is a function of a desired punching force which the punching tools must exert on the piece 100 to perform the required machining.

The hydraulic drive system 1 comprises an oil reservoir 15, at atmospheric pressure, which is connected to a mouth of the first pump 3 via a discharge circuit 14, the other mouth of the first pump 3 being connected to the hydraulic cylinders 2 through the supply circuit 12. In the driving phase, the first pump 3 draws oil from the reservoir 15 and sends it pressurized to the hydraulic cylinders 2; in the sucking phase, the first pump 3 pours into the reservoir 15 the oil sucked by the hydraulic cylinders 2.

The hydraulic drive system 1 also includes a plurality of selector valves 4, in particular inserted in the supply circuit 12, each of which is interposed between the first pump 3 and the thrust chamber 22 of a respective hydraulic cylinder 2 and activable in opening to put the first pump 3 into flow connection with the thrust chamber 22 so as to operate the hydraulic cylinder 2 and the relevant punching tool 51 in the working direction.

A hydraulic or pressurized accumulator 5 is connected to the return chambers 23 of the hydraulic cylinders 2, in particular by means of a return circuit 13 formed by a plurality of return ducts. The hydraulic accumulator 5, of known type and therefore not described further in detail, is arranged for maintaining the oil at a defined preload pressure in the return chambers 23 of the cylinders, in particular for moving along the return direction one or more pistons 21 of the hydraulic cylinders 2 which are selectively operated by activating the corresponding selector valves 4.

It should be noted that the oil preload pressure in the return chambers 23 of the hydraulic cylinders 2 confers greater rigidity to the latter ones and to the supply circuit 12 and return circuit 13, i.e. to the entire hydraulic drive system 1 which is in this way more reactive and precise in the movements of the pistons 21 and therefore of the punching tools 51 during the machinings performed on the piece 100.

It should also be noted that, in each hydraulic cylinder 2, the punching force that the punching tool 51 is able to exert on the piece 100 is given by the difference between a thrust force in the obtained working direction in the thrust chamber 22 from the oil at the supply pressure acting on the piston 21 and an opposite contrast force in the return direction obtained in the return chamber 23 from the oil at the preload pressure acting on the piston 21.

The hydraulic drive system 1 comprises an electric motor 6 controlled by a control unit 10, for instance the control unit of the punching apparatus 50, and arranged to drive the first pump 3 of the reversible type in both rotation directions and in such a way that the first pump 3 delivers a defined flow rate of pressurized oil. More precisely, the control unit 10 regulates the operation of the electric motor 10, in particular by varying the rotation torque, speed and acceleration of the motor shaft 6a which drives the first pump 3 according to the working conditions, such as for example the number of punching tools 51 (i.e. hydraulic cylinders 2) to be operated, the punching force to be exerted on the workpiece 100 (i.e. oil supply pressure to the hydraulic cylinders). For this purpose, the hydraulic drive system 1 comprises a plurality of pressure sensors 17 inserted in the supply circuit 12, each of which is associated with a respective hydraulic cylinder 2 and capable of measuring a pressure of the oil in the thrust chamber 3. The pressure sensors 17 are connected to the control unit 10 to send to it signals relating to the detected pressures.

In the embodiment shown in the figures, the hydraulic drive system 1 of the invention comprises a second pump 7, also of the reversible type, coupled and connected to the first pump 3, in particular by means of a transmission shaft and substantially identical to the first pump 3. The two pumps 3, 7 are operated by the same electric motor 6 controlled by the control unit 10 so as to rotate together at the same speed and deliver a defined flow rate of pressurized oil to the hydraulic cylinders 2.

In a variant of the hydraulic drive system 1 of the invention not shown in the figures, the first pump 3 and the second pump 7 are integrated in a single pump provided with two combined pumping units.

A first differential valve 8 is interposed between the second pump 7 and the thrust chambers 22 of the hydraulic cylinders 2 and activable when the supply pressure P_{A} exceeds a first working pressure P₁ in at least one of the thrust chambers 22 so as to connect the second pump 7 to the oil reservoir 15 so as to by-pass or place into recirculation the second pump 7 and allow to transfer all the power of the electric motor 6 to the first pump 3 which is able to push and compress the oil at higher pressure values. The first differential valve 8 is, for example, a three-way valve inserted in the supply circuit 12 and connected to the reservoir 15 via a first discharge duct 16. The first differential valve 8 is, for example, controlled and activated by the control unit 10 on the basis of the pressure signals sent by the pressure sensors 17. Alternatively, the first differential valve 8 can be a servo-valve driven by a pilot valve activated by the pressure of the oil in the supply circuit 12.

The hydraulic drive system 1 further comprises a second differential valve 9 interposed between the hydraulic accumulator 5 and the return chambers 23 of the hydraulic cylinders 2 and activable when the supply pressure P_{A} exceeds a second working pressure P₂ in at least one of the thrust chambers 22 so as to connect the return chambers 23 to the reservoir 15 and put the latter into discharge, i.e. at atmospheric pressure. In this way, although the supply pressure P_{A} of the oil in the thrust chambers 22 remains constant, the punching force increases as the pressure in the return chambers 23 decreases to the atmospheric value. It is therefore possible in this way to contain the value of the supply pressure P_{A} and reduce power consumption of the first pump 3.

The value of the second working pressure P2 is higher than that of the first working pressure P1.

The second differential valve 9 is, for example, a three-way valve inserted in the return circuit 13 and connected to the reservoir 15 via a second discharge duct 18. The second differential valve 9 is for example controlled and activated by the control unit 10 on the basis of the pressure signals sent by the pressure sensors 17. Alternatively, the second differential valve 9 can be a servo-valve driven by a pilot valve activated by the pressure of the oil in the supply circuit 12.

The operation of the hydraulic drive system 1 of the invention associated with the multi-press punching apparatus 50 provides for moving the punching tool or tools 51 necessary to perform the required machinings on the piece 100, for example two in the exemplary working configuration of FIG. 2, driving the respective hydraulic cylinders 2. The latter ones are operated by activating and opening the corresponding selector valves 4 and driving the first pump 3 and the second pump 7 in a first rotation direction so as to send pressurized oil to the thrust chambers 22. More precisely, the electric motor 2 is controlled by the control unit 10 so as to rotate the pumps in the first rotation direction with a defined speed and torque so that the pumps 3, 7 deliver a stable flow rate of oil at a supply pressure P_{A} which is related to the punching force to be exerted on the piece 100, i.e. by the resistance that the latter opposes to the machining. Since the punching force, which depends on the type of tool used (shape, size, . . . ), on the specific machining to be performed (drilling, cutting, deformation, . . . ) and on the material of the piece 100, can vary, in particular increase during performance of the machining, also the supply pressure P_{A} can vary (increase) inside the thrust chambers 22, thus causing an increase in the torque or power that the electric motor 6 must supply the pumps 3, 7 so that the latter ones supply the required supply pressure P_{A}.

It should be noted that the punching force, i.e. the effective force exerted by the piston 21 on the punching tool 51 is given by the difference between the thrust force along the working direction given in the thrust chamber 22 by the oil at the supply pressure P_{A} acting on the piston 21 and the contrast force along the return direction provided in the return chamber 23, connected to the accumulator 5, from the oil to the preload pressure acting on the piston 21. It should also be noted that the oil preload pressure in the return chambers 23 of the hydraulic cylinders 2 confers rigidity to the latter ones and to the supply circuit 12 and return circuit 13, i.e. to the entire hydraulic drive system 1 which is in this way more reactive and precise.

Once the machinings have been performed on the piece 100, the punching tools 51 are disengaged and moved away from the latter by moving the pistons 21 of the respective hydraulic cylinders 2 in the return direction. This is achieved by reversing the rotation direction of the electric motor 2, i.e. by rotating the pumps 3, 7 in the opposite second rotation direction, so as to suck oil from the thrust chambers 22 and convey it towards the reservoir 15. In this way, the pressure of the oil in the thrust chambers 22 is reduced (to a value close to that of the atmospheric pressure) allowing the oil contained in the return chambers 23 at the preload pressure (secured by the hydraulic accumulator 5) to push the pistons 21 in the return direction.

It should be noted that the use of the hydraulic accumulator 5 to move the pistons 21 in the return direction allows the hydraulic drive system 1 to be simplified and made more economical since it avoids the use of further selector valves to convey the oil dispensed from pumps 3, 7 to the return chambers 23. Moreover, the power consumption of the electric motor 6 and of the pumps 3, 7, substantially operated to connect the thrust chambers 22 to the reservoir 15, are minimum and lower than those that would be necessary for the pumps 3, 7 to move the pistons 21 in the return direction.

FIG. 3 illustrates another working configuration of the hydraulic drive system 1 of the punching apparatus 50, which provides for operating a single punching tool 51 by activating the corresponding selector valve 4 which allows the pumps 3, 7 to send the pressurized oil to the respective hydraulic cylinder 2. In this configuration, in the stroke of the piston 21 and of the punching tool 51, the punching force increases progressively and with it the supply pressure P_{A} inside the thrust chamber 22. When the first working pressure P₁ is exceeded, the second pump 7 is placed into recirculation, i.e. it is connected in delivery to the oil reservoir 15 to send the oil to the latter, activating the first differential valve 8. In this way, the second pump 7 is substantially excluded from operation and all the power of the electric motor 6 is supplied to the first pump 3 which can therefore guarantee the required increase in the supply pressure P_{A}. More precisely, it is possible to increase the supply pressure P_{A}, with a reduction in the flow rate of the oil, i.e. in the speed of the piston 21, substantially without increasing the power of the electric motor 6 or increasing it only to a limited extent, thus allowing to contain power consumption of the whole supply system 1.

Proceeding with the machining, if the punching force increases further and with it the supply pressure P_{A} inside the thrust chamber 22, when the second working pressure P₂ is exceeded, the second differential valve 9 is activated, which puts in flow connection the return chambers 23 to the reservoir 15, i.e., puts the return chambers 23 into discharge, at atmospheric pressure. In this way, the supply pressure P_{A} of the oil in the thrust chambers 22 can remain substantially constant (and equal to the second working pressure P₂) or increase limitedly, but the effective force exerted by the piston 21 in the working direction, i.e. the punching force, increases considerably since the pressure in the return chambers 23 decreases to the atmospheric value, i.e., the contrast force of the piston in the return direction decreases. In other words, by discharging the return chambers 23 by means of the second differential valve 9, it is possible to considerably increase the punching force without the need to increase the supply pressure P_{A} or to increase the power of the electric motor 2, thereby allowing to contain power consumption.

Also in this case, once machining on the workpiece 100 has ended, the punching tool 51 is disengaged and moved away from the workpiece 100 by moving the piston 21 in the return direction, in particular by rotating the pumps 3, 7 in the opposite second rotation direction in such a way as to suck oil from the thrust chambers 22 and convey it towards the reservoir 15 and deactivating the second differential valve 9 so as to connect the return chambers 23 to the hydraulic accumulator 5 again. In this way, the pressure of the oil in the thrust chambers 22 is reduced, allowing the oil contained in the return chambers 23 at the preload pressure (guaranteed by the hydraulic accumulator 5) to push the pistons 21 in the return direction.

Thanks to the hydraulic supply system 1 of the invention associable to a multi-press punching apparatus 50, it is therefore possible to operate in a precise and accurate way, individually and independently, a plurality of punching tools 51 of the aforementioned punching apparatus to perform one or more machinings at the same time on the piece 100. More precisely, by activating the selector valves 4 it is possible to select the hydraulic cylinders 2 to be operated to move the respective punching tools 51.

By adjusting the speed of rotation of the pumps 3, 7 by acting on the electric motor 6 controlled by the control unit 10, it is possible to adjust the flow rate and the supply pressure of the oil in the thrust chambers 22 of the hydraulic cylinders 2, and therefore it is possible to precisely and accurately control the position, displacement and speed of the pistons 21 and the respective punching tools 51 along the working axes A. The precision and reactivity, i.e. the ability to react to the commands and the adjustments (changes in the flow rate and/or pressure of the oil in the cylinders) of the hydraulic cylinders 2 and of the entire hydraulic drive system 1 of the invention, are also ensured by the rigidity of the latter obtained, as already highlighted, connecting the return chambers 23 of the hydraulic cylinders 2 to the hydraulic accumulator 5 which maintains the oil at a defined preload pressure.

The hydraulic accumulator 5 which allows to move the pistons 21 in the return direction also makes it possible to simplify and make less costly the hydraulic drive system 1 since it avoids the use of further selector valves to convey the oil supplied by the pumps 3, 7 to the return chambers 23 and reduces the power consumption of the electric motor 6 and of the pumps 3, 7 which must not deliver pressurized oil to move the aforementioned pistons 21 in the return direction.

The hydraulic drive system 1 of the invention also has reduced power consumption and high power efficiency thanks to the use of the two differential valves 8, 9 which are activated when the supply pressure P_{A} in the hydraulic cylinders 2 respectively reaches a first working pressure P₁ and a second working pressure P₂. More precisely, when the supply pressure P_{A} exceeds the first working pressure P₁, the second pump 7 is placed into recirculation, that is connected in delivery to the oil reservoir 15, activating the first differential valve 8, so that the electric motor 6 in fact drives only the first pump 3. It is therefore possible to guarantee the required increase in the supply pressure P_{A} without increasing the power and therefore the power consumption of the electric motor 6.

When the supply pressure P_{A} exceeds the second working pressure P₂ the second differential valve 9, that puts the return chambers 23 and the reservoir 15 in flow connection, is also activated. Thus, the supply pressure P_{A} of the oil in the thrust chambers 22 can remain substantially constant or increase limitedly, since the effective force exerted on the piston 21 in the working direction, i.e. the punching force, increases by decreasing the pressure in the return chambers 23. The punching force is increased without the need to increase the supply pressure P_{A}, i.e. to increase the power of the electric motor 2.

The hydraulic drive system 1 of the invention is therefore more efficient in energy consumption than the known driving systems for multi-press punching apparatuses.

It should also be noted that the hydraulic drive system 1 of the invention comprises a limited number of valves and the use of a normal hydraulic accumulator is simple and economical and with reduced and compact dimensions and space requirements.

The method according to the invention for operating in a separate and independent manner a plurality of punching tools 51 of the multi-press punching apparatus 50 provided with the hydraulic drive system 1 described above and illustrated in FIGS. 1 to 3 involves:
selecting at least one punching tool 51 to be operated by activating in opening the respective selector valve 4 which is interposed between the first pump 3, of the reversible type and arranged to deliver oil at the supply pressure P_{A}, and the hydraulic cylinder 2 acting on the selected punching tool 51;
driving the first pump 3 in a first rotation direction in order to send the pressurized oil into a thrust chamber 22 of the hydraulic cylinder 2 so as to push the piston 21 thereof along a working direction and enabling the selected punching tool 51 associated therewith to perform a machining on the piece 100;
once said machining is performed, driving the first pump 3 in an opposite second rotation direction in order to suck oil from the thrust chamber 22, the piston 21 being pushed along a return direction, to enable the punching tool 51 to disengage and move away from the piece 100, by means of pressurized oil sent to the return chamber 23 of the hydraulic cylinder 1 by a hydraulic accumulator 5.

The method also involves, during the driving of the first pump 3, driving also a second pump 7, in particular coupled and connected to the first pump 3, in the first rotation direction in order to send oil to the thrust chamber 22 of the hydraulic cylinder 2 up to a first working pressure P₁, over which the second reversible pump 7 is placed into recirculation connecting it to the reservoir 15, in which the oil is sent, by activating the first differential valve 8.

During the driving of the first reversible pump 3, connecting the return chamber 23 of the hydraulic cylinder 2 to the reservoir 15, by activating the second differential valve 9, when the pressure of the oil in the thrust chamber 22 exceeds a second working pressure P2, is also involved.

1. A hydraulic drive system associable with a multi-press punching apparatus for operating a plurality of punching tools of said punching apparatus along respective operating axes in a separate and independent manner so as to interact with a workpiece, comprising:
a plurality of hydraulic cylinders, wherein each hydraulic cylinder is associated with a respective punching tool and provided with a respective piston that defines a thrust chamber and a return chamber inside the hydraulic cylinder and is associated with the corresponding punching tool for moving the corresponding punching tool along the respective operating axis;
a first pump of reversible type connected to said thrust chambers of said hydraulic cylinders and arranged to send oil at a supply pressure at least in one of said thrust chambers so as to push the respective piston along a working direction and allow the punching tool associated therewith to interact with the workpiece, or to suck oil from at least said thrust chamber to allow the respective piston moving along a return direction and said punching tool disengaging and moving away from said workpiece;
a plurality of selector valves, wherein each selector valve is associated with a respective hydraulic cylinder, interposed between said first pump and the thrust chamber of the hydraulic cylinder and activable to put into flow connection the first pump with the thrust chamber so as to operate the hydraulic cylinder;
a hydraulic accumulator connected to said return chambers of said hydraulic cylinders and arranged for maintaining in said return chambers oil at a defined preload pressure.

2. The hydraulic drive system according to claim 1, comprising an electric motor controlled by a control unit and arranged to drive said first pump of reversible type in both rotation directions and in such a way that it delivers a defined oil flow rate at a defined supply pressure.

3. The hydraulic drive system according to claim 2, comprising a second pump of reversible type coupled and connected to said first pump, wherein said pumps are operated by a same electric motor controlled by a control unit and arranged to drive said pumps in both rotation directions and in such a way that they deliver a defined oil flow rate at a set supply pressure.

4. The hydraulic drive system according to claim 3, comprising a first differential valve interposed between said second pump and said thrust chambers and activable when said supply pressure exceeds a first working pressure in at least one of said thrust chambers so as to connect said second pump to an oil reservoir.

5. The hydraulic drive system according to claim 1, comprising a second differential valve interposed between said hydraulic accumulator and said return chambers and activable when said supply pressure exceeds a second working pressure in at least one of said thrust chambers so as to connect said return chambers to an oil reservoir.

6. The hydraulic drive system according to claim 4, comprising a second differential valve interposed between said hydraulic accumulator and said return chambers and activable when said supply pressure exceeds a second working pressure in at least one of said thrust chambers so as to connect said return chambers to an oil reservoir, wherein said second working pressure is higher than said first working pressure.

7. The hydraulic drive system according to claim 1, comprising an oil reservoir from which oil is sucked by at least said first pump when driven in a first rotation direction in order to send oil at the supply pressure to said hydraulic cylinders and in which oil is sent when said first pump is driven in an opposite second rotation direction in order to suck oil from said hydraulic cylinders.

8. A multi-press punching apparatus comprising a hydraulic drive system according to claim 1 for operating a plurality of punching tools along respective operating axes in a separate and independent manner.

9. A method for operating in a separate and independent manner a plurality of punching tools of a multi-press punching apparatus provided with a hydraulic drive system according to claim 1, comprising:
selecting at least one punching tool to be operated by activating a respective selector valve interposed between a first pump, which is of reversible type and arranged to deliver oil at a supply pressure, and a hydraulic cylinder acting on said punching tool;
driving said first pump in a first rotation direction in order to send pressurized oil into a thrust chamber of said hydraulic cylinder so as to push a piston thereof along a working direction and enable a punching tool associated therewith to perform a machining on a workpiece;
once said machining is performed, driving said first pump in an opposite second rotation direction in order to suck oil from said thrust chamber, wherein said piston is pushed along a return direction by pressurized oil sent to a return chamber of said hydraulic cylinder by a hydraulic accumulator to enable said punching tool to disengage and move away from said workpiece.

10. The method according to claim 9, comprising during said driving said first pump further driving in said first rotation direction a second pump of reversible type in order to send oil in said thrust chamber up to a first working pressure, over which said second pump is connected to a reservoir in which said second pump send the oil, by activating a first differential valve.

11. The method according to claim 9, comprising during said driving said first pump connecting said return chamber to an oil reservoir by activating a second differential valve, when the supply pressure in said thrust chamber exceeds a second working pressure.

12. The hydraulic drive system according to claim 4, wherein said oil reservoir is at atmospheric pressure.

13. The hydraulic drive system according to claim 5, wherein said oil reservoir is at atmospheric pressure.
